(19) United States
(12) Patent Application Publication
(10) Pub. No.: US 2025/0144742 A1
(43) Pub. Date: May 8, 2025

(54) METHOD FOR JOINING TWO ANODISED ELEMENTS BY FRICTION STIR WELDING

(71) Applicant: SAFRAN NACELLES, Gonfreville-L'Orcher (FR)

(72) Inventors: Virginie Emmanuelle Anne-Marie Digeos, Moissy-Cramayel (FR); Nicolas Serre, Moissy-Cramayel (FR); Florian Peu, Moissy-Cramayel (FR); Xavier Holay, Moissy-Cramayel (FR)

(73) Assignee: SAFRAN NACELLES, Gonfreville-L'Orcher (FR)

(21) Appl. No.: 18/835,909

(22) PCT Filed: Feb. 8, 2023
(86) PCT No.: PCT/FR2023/050172

§ 371 Date: Aug. 5, 2024

(30) Foreign Application Priority Data
Feb. 10, 2022 (FR) 2201180

(51) Int. Cl. B23K 20/12; B23K 20/233; B23K 101/34; B23K 103/10

(52) U.S. Cl. CPC B23K 20/1265; B23K 20/129; B23K 20/2336; B23K 2101/35; B23K 2103/10

(57) ABSTRACT

The present application describes a method for joining two anodized elements by friction stir welding. This method for joining a first element to a second element comprises a step of anodizing the first element, a step of anodizing the second element, and a step of producing a weld seam by friction stir welding the first element to the second element.

### TECHNICAL FIELD

The present invention relates to methods for joining by means of friction stir welding.

In particular, the present invention relates to protecting surfaces joined by friction stir welding, in particular protecting them from corrosion.

Generally speaking, the invention can be applied to any type of application requiring two components to be joined by friction stir welding.

### PRIOR ART

In industry, and in particular in the aeronautics industry, it is common to have to join several elements together. This can involve, for example, joining a stiffener to a structural panel of an aircraft in order to reinforce said structural panel.

Manual riveting is the most common of the various joining methods, also providing protection from corrosion for the elements joined together. However, riveting involves long joining times due to its manual nature.

Friction stir welding is a faster joining method that can be automated. It uses a rotating pin less than 5 millimetres in diameter to stir together the materials of the elements to be joined, creating a weld. Friction stir welding is suitable in particular for aluminium alloys.

FIG. 1 schematically shows an embodiment of a friction stir welding method. FIG. 1 shows a sectional view of the assembly of a structural panel 2 with a stiffener 4, the structural panel 2 and the stiffener 4 each a few millimetres thick. For friction stir welding, a pin 6 moves against the stiffener 4 while being kept rotating. The pin 6 thus stirs and mixes the materials of the stiffener 4 and structural panel 2 so as to create a weld seam 8 joining the two elements.

However, the weld seam 8 does not fully cover the contact surfaces 10 between the structural panel 2 and the stiffener 4. Non-welded areas 12 can become areas that retain liquid and are liable to corrode.

Solutions for preventing corrosion exist with the addition of an interposing sealant in the non-welded areas 12.

Nevertheless, the sealant is damaged and loses its sealing properties during welding and the weld seam 8 loses its mechanical properties due to pollution by incorporating sealant into the material of the weld seam 8.

### DISCLOSURE OF THE INVENTION

The object of the present invention is therefore to overcome the aforementioned drawbacks and provide a joining method by means of friction stir welding without the risk of corrosion on the non-welded areas.

One object of the present invention is a method for joining a first element to a second element comprising a step of anodising the first element, a step of anodising the second element and a step of producing a weld seam by friction stir welding the first element to the second element.

In this way, anodising the first and second elements protects the non-welded interface and prevents corrosion of the first and second elements during friction stir welding at the non-welded areas, which welding enables quick and automated joining.

In one particular embodiment, the method also comprises a step of oxidising the weld seam once the friction stir welding has been carried out.

The step of oxidising the weld seam is advantageously achieved by local anodising or chemical conversion.

In one embodiment, the method comprises an optional step of reactivating the anodising of the first element and second element once the friction stir welding has been carried out.

The method also advantageously comprises an optional step of applying a paint system comprising a primer.

In one embodiment, the method comprises a step of applying sealant to a contact area between the first element and the second element so as to seal off access to an area not welded by the weld seam.

Advantageously, at least one of the steps of anodising the first element or anodising the second element is a step of sulfuric or sulfo-tartaric anodising.

Advantageously, the first element and the second element each comprise an aluminium alloy.

### BRIEF DESCRIPTION OF THE DRAWINGS

Other aims, features and advantages of the invention will become apparent upon reading the following description, provided solely by way of non-limiting example, and with reference to the appended drawings in which:

FIG. 1, which has already been referenced, is a sectional view of a stiffener and a structural panel joined together by a friction stir welding method;

FIG. 2 is a flowchart schematically showing the step of a method for joining a first element to a second element according to the invention; and

FIG. 3 is a schematic sectional view of a first element and a second element joined together by a joining method according to the invention; and

FIG. 4 is a schematic sectional view of a first element and a second element joined together by a joining method according to the invention comprising a step of applying sealant; and

FIG. 5 is a variant of the schematic sectional view shown in FIG. 4 showing a first element and a second element joined together by a joining method according to the invention comprising a step of applying sealant.

### DETAILED DISCLOSURE OF AT LEAST ONE EMBODIMENT

FIG. 2 schematically shows the steps for carrying out a method for joining a first element to a second element.

The first element is, for example, made of an aluminium alloy, for example a 2219 alloy or any other alloy that can be welded by friction stir welding. Similarly, the second element is made of an aluminium alloy.

FIG. 3 is a schematic sectional view of the final assembly of the first element 14 with the second element 16. In this particular embodiment, the first element 14 is a stiffener and the second element 16 is a structural panel of an aircraft.

In order to carry out this method, a step 18 of anodising the first element 14 is carried out first of all.

At the same time, a step 20 of anodising the second element 16 is also carried out.

Anodising is also referred to as anodic oxidation and is well known to a person skilled in the art. Anodising is, for example, sulfuric or sulfo-tartaric anodising. Anodising can also be sulfo-boric or chromic anodising. Anodising creates a first layer 22 around the first element 14 and a second layer 24 around the second element 16, the first and second layers 22 and 24 being electrically insulating and protecting against corrosion. The layers 22 and 24 produced are between 2 and 15 micrometres thick, for example.

A step of sealing the anode layer can be carried out and is known to a person skilled in the art.

Once the first and second elements 14 and 16 have been anodised, a weld seam 26 is produced during a step 28. The weld seam 26 is produced by friction stir welding.

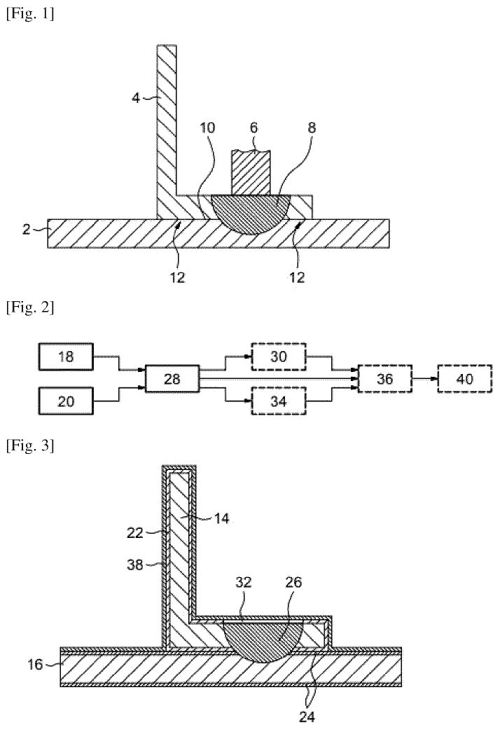

For example, friction stir welding is carried out in an overlapping configuration of the first element 14 to the second element 16, with planar surfaces of the first and second elements being brought into contact with each other so as to weld the first element 14 to the second element 16. The material of the second element 16 is mixed by a pin (identical to the pin 6 shown in FIG. 1) with the material of the first element 14 through the first element 14. The welding parameters are determined such that the anodised layers are crushed in the weld seam 26 and the mechanical features of the weld are satisfactory. For this, the key parameters for achieving a well crushed anodised layer are the choice of tool, the number of passes to be made, the feed and rotation speed, the tool inclination and the overlap between passes. Each of the parameters is to be defined according to the material and the thickness of the anodised layer, the thickness of the anodised layers depending on the method used, sulfuric anodising generating thicker layers than chromic anodising, for example.

Alternatively, welding can also be carried out by butt welding between two already anodised elements, followed by local touch-up on both sides of the seam by chemical conversion or local anodising.

Anodising advantageously enables the weld seam 26 to meet the necessary mechanical performance requirements although part of the first and second layers 22 and 24 are mixed and contained in the weld seam 26.

Optionally, once the weld seam 26 has been produced, a step 30 is carried out of oxidising the weld seam 26, in particular its outer face on the side of the first element 14 so as to also protect its surface from corrosion.

The oxidation step 30 thus creates a third layer 32 on the visible surface of the weld seam 26. The oxidation step 30 is, for example, carried out by local anodising or chemical conversion.

Optionally, it is also possible to carry out a step 34 of reactivating the anodising of the first element 14 and second element 16. This step 34 can be carried out straight after the welding step 28 or at the same time as the step 30 of oxidising the weld seam 26, or even after this step 30. The step 34 of reactivating the anodising involves carrying out a step of applying a reactivation product so as to restore the effects of the anodising steps 18 and 20 and to allow better adhesion of a paint system, as the layers 22 and 24 may have deteriorated during the step 28 of producing the weld seam 26.

In order to improve the protection of the first and second elements 14 and 16 against corrosion, an optional step 36 of applying a paint system 38 is carried out. The step of applying a paint system 38 can be carried out without having first carried out the preceding steps 30 and 34. The step 36 of applying a paint system can, however, be carried out after one of or after both steps 30 and 34 of oxidation and reactivating the anodising.

The paint system 38 comprises, for example, a primer, preferably an anti-corrosion primer. Other coats of paint can also be applied over the primer.

In order to ensure that the joint is sealed, an optional step 40 is carried out of applying sealant 42 to a contact area 44 between the first element 14 and the second element 16. The sealant 42 is applied, for example, in the form of a bead along the contact area 44.

The contact area 44 corresponds to an area for accessing an area 46 not welded by the weld seam 26, similar to the non-welded areas 12 shown in FIG. 1. This step 40 can be carried out instead of the step 36 of applying a paint system 38.

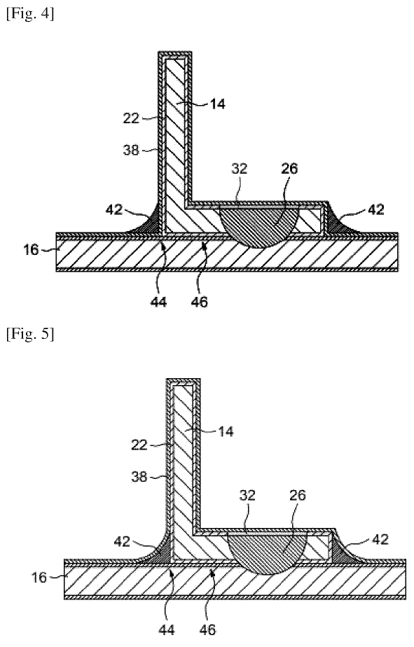

Two other embodiments of the joining method are also shown in FIGS. 4 and 5. FIG. 4 shows the assembly of the first element 14 with the second element 16 when the step 40 of applying sealant 42 is carried out after the step 36 of applying a paint system 38.

FIG. 5 shows the assembly of the first element 14 with the second element 16 when the step 40 of applying sealant 42 is carried out before the step 36 of applying a paint system 38.

1. Method for joining a first element to a second element, the method comprising a step of anodising the first element, a step of anodising the second element and a step of producing a weld seam by friction stir welding the first element to the second element, the method also comprising a step of oxidising the weld seam once the friction stir welding has been carried out.

2. Method according to claim 1, wherein the step of oxidising the weld seam is achieved by local anodising or chemical conversion.

3. Method according to claim 1, comprising a step of reactivating the anodising of the first element and second element once the friction stir welding has been carried out.

4. Method according to claim 1, comprising a step of applying a paint system comprising a primer.

5. Method according to claim 1, also comprising a step of applying sealant to a contact area between the first element and the second element so as to seal off access to an area not welded by the weld seam.

6. Method according to claim 1, wherein at least one of the steps of anodising the first element or anodising the second element is a step of sulfuric or sulfo-tartaric anodising.

7. Method according to claim 1, wherein the first element and the second element each comprise an aluminium alloy.
